(19) United States
(12) Patent Application Publication
(10) Pub. No.: US 2017/0261057 A1
(43) Pub. Date: Sep. 14, 2017

(54) FRICTION MATERIAL WITH HIGH PERFORMANCE SURFACE LAYER

(71) Applicant: Schaeffler Technologies AG & Co. KG, Herzogenaurach (DE)

(72) Inventors: Rashid Farahati, Copley, OH (US); Murat Bakan, Puebla (MX)

(73) Assignee: Schaeffler Technologies AG & Co. KG, Herzogenaurach (DE)

(21) Appl. No.: 15/065,327

(22) Filed: Mar. 9, 2016

(51) Int. Cl. F16D 69/02; B05D 5/00; B05D 1/28; F16H 45/02; B05D 1/02

(52) U.S. Cl. CPC F16D 69/026; F16H 45/02; B05D 1/02; B05D 1/28; B05D 5/00; F16D 69/023; F16H 2045/0273; F16D 2300/10; F16D 2069/008

(57) ABSTRACT

A friction material for a clutch pad comprising: a base layer including: a plurality of fibers; and, a filler material; and, a surface layer, substantially devoid of fibers, including: a friction modifier; and, a coupling agent. A method of making a friction material composite, the method comprising: forming a base layer, having oppositely disposed first and second surfaces and a first density, and including a plurality of fibers and a filler material; mixing a friction modifier and an organosilane coupling agent to form a mixture; applying the mixture uniformly to the first surface of the base layer to form a friction modifying surface layer, having oppositely disposed third and fourth surfaces and a second density, and an interfacial bonding layer therebetween; and, saturating the base layer, the interfacial bonding layer, and the friction modifying surface layer with a binder.

### FIELD

The present disclosure relates generally to a wet friction material for clutch pads, in particular, a wet friction material with a high performance surface layer.

### BACKGROUND

US 2005/0075414 A1, hereby incorporated by reference herein, relates to a friction material having a high fiber content fibrous base material as a primary layer and a secondary layer of friction modifying particles.

WO 2013/156244 A2, hereby incorporated by reference herein, relates to a mating surface of a friction pairing which comprises a friction surface that can be connected and/or is connected to the mating surface in a friction-fit manner in the operation of the friction pairing for torque transmission.

European Patent EP1095999 B1 relates to a friction lining with at least two layers.

### BRIEF SUMMARY

Example aspects broadly comprise a friction material for a clutch pad comprising: a base layer including: a plurality of fibers; and, a filler material; and, a surface layer, substantially devoid of fibers, including: a friction modifier; and, a coupling agent. In an example aspect, the surface layer has a higher density than the base layer. In an example aspect, the coupling agent forms an interfacial bonding layer between the base layer and the surface layer; and, wherein the base layer, interfacial boding layer, and surface layer form a composite. In an example aspect, the composite is saturated with a binder. In an example aspect, the binder is selected from the group: a phenolic resin, a latex, a silane, or a mixture thereof. In an example aspect, the binder is phenolic resin. In an example aspect, the plurality of fibers are selected from the group: organic fibers, inorganic fibers, cellulose fibers, cotton fibers, aramid fibers, carbon fibers, or a combination thereof. In an example aspect, the filler material is a first silica-containing material. In an example aspect, the first silica-containing material is selected from the group: diatomaceous earth, silicon dioxide, calcium silicate, or a combination thereof. In an example aspect, the friction modifier is activated carbon. In an example aspect, the friction modifier is a second silica-containing material selected from the group: diatomaceous earth, silicon dioxide, calcium silicate, calcined kaolin, or a combination thereof. In an example aspect, the friction modifier is a second silica-containing material. In an example aspect, the second silica-containing material is selected from the group: diatomaceous earth, silicon dioxide, calcium silicate, or a combination thereof. In an example aspect, the silica-containing material is Celite®. In an example aspect, the filler material and the friction modifier are the same or different. In an example aspect, the coupling agent is an organosilane. In an example aspect, the organosilane is 3-ureidopropyl-triethoxysilane or γ-aminopropyltriethoxysilane.

Other example aspects broadly comprise a friction material composite for a clutch comprising: a base layer including: a plurality of fibers; and, a filler material; and, a surface layer, substantially devoid of fibers, including: a friction modifier; and, a coupling agent; and, an interfacial bonding layer disposed between the base layer and surface layer and including the coupling agent and at least partially the plurality of fibers, the filler material, and the friction modifier.

Other example aspects broadly comprise a torque converter comprising: a clutch; a plate; the friction material as in the above paragraphs disposed between the clutch and the plate.

Other example aspects broadly comprise a method of making a friction material composite, the method comprising: forming a base layer, having oppositely disposed first and second surfaces and a first density, and including a plurality of fibers and a filler material; mixing a friction modifier and an organosilane coupling agent to form a mixture; applying the mixture uniformly to the first surface of the base layer to form a friction modifying surface layer, having oppositely disposed third and fourth surfaces and a second density, and an interfacial bonding layer therebetween; and, saturating the base layer, the interfacial bonding layer, and the friction modifying surface layer with a binder. In an example aspect, the step of applying includes spraying or brush rolling. In an example aspect, the step of mixing includes Celite as the friction modifier and 3-ureidopropyl-triethoxysilane or γ-aminopropyltriethoxysilane as the organosilane; and wherein the step of saturating includes a phenolic resin as the binder.

### BRIEF DESCRIPTION OF THE DRAWINGS

The nature and mode of operation of the present invention will now be more fully described in the following detailed description of the invention taken with the accompanying drawing figures, in which:

FIG. 1 illustrates a schematic cross-sectional view of a friction material including a high performance surface layer according to an example aspect;

FIG. 2 illustrates a schematic cross-sectional view in detail of the Area C of FIG. 1; and,

FIG. 3 illustrates a cross-sectional view of a torque converter having friction material including a high performance surface layer according to an example aspect.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. Although any methods, devices or materials similar or equivalent to those described herein can be used in the practice or testing of the invention, the following example methods, devices, and materials are now described.

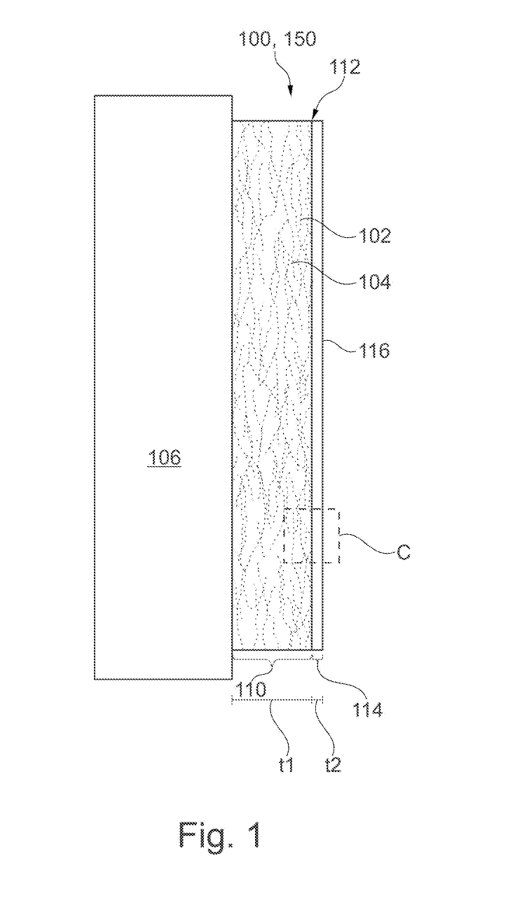

The following description is made with reference to FIGS. 1-3. Wet friction materials as known in the art are useful for example for clutches. In an example aspect, a friction material for a clutch comprises a plurality of fibers and a filler material. FIG. 1 is a schematic cross-sectional view of friction material 100 including a high performance surface layer. In an example aspect, friction material 100 can be used on any clutch plate 106 known in the art. In an example embodiment, friction material 100 is fixedly secured to plate 106.

Friction material 100 includes fiber material 102 and filler material 104. Fiber material 102 can be any organic or inorganic fiber known in the art, for example including but not limited to cellulose fibers, cotton fibers, aramid fibers, carbon fibers, or any combination thereof. In an example aspect, plurality of fibers 102 are selected from the group: organic fibers, inorganic fibers, cellulose fibers, cotton fibers, aramid fibers, carbon fibers, or any combination thereof.

In an example aspect, filler material 104 includes at least a plurality of at least one silica-containing material. Any inorganic, silica-containing material known in the art can be used. In an example embodiment, the silica-containing material includes, but is not limited to: Celite®, Celatom®, diatomaceous earth, or silicon dioxide. Silicon dioxide is also referred to as silica or SiO₂. Typically diatomaceous earth is amorphous.

Other silica-containing materials such as calcium silicate can also be used. Calcium silicate is known generally as one of a group of compounds obtained by reacting calcium oxide and silica in various ratios e.g. 3CaO.SiO₂, Ca₃SiO₅; 2CaO.SiO₂, Ca₂SiO₄; 3CaO.2SiO₂, Ca₃Si₂O₇ and CaO.SiO₂, CaSiO₃. Calcium silicate is a white free-flowing powder derived from limestone and diatomaceous earth and is also known as calcium orthosilicate. Calcium silicate can be derived naturally or can be synthetically made with specific characteristics and properties.

Friction material 100 further includes binder B (not shown), such as a phenolic resin, a latex, a silane, or a mixture thereof. Friction material 100 is saturated with binder after the high performance surface layer is applied so that the composite 150 is saturated or impregnated with binder throughout. Typically, binder B of friction material 100 includes a phenolic resin as known in the art. Phenolic resin upon curing forms water as a byproduct of a reaction between a phenol and a formaldehyde. In an example aspect, non-limiting example Arofene® 295-E-50 is useful as impregnating resin for friction paper.

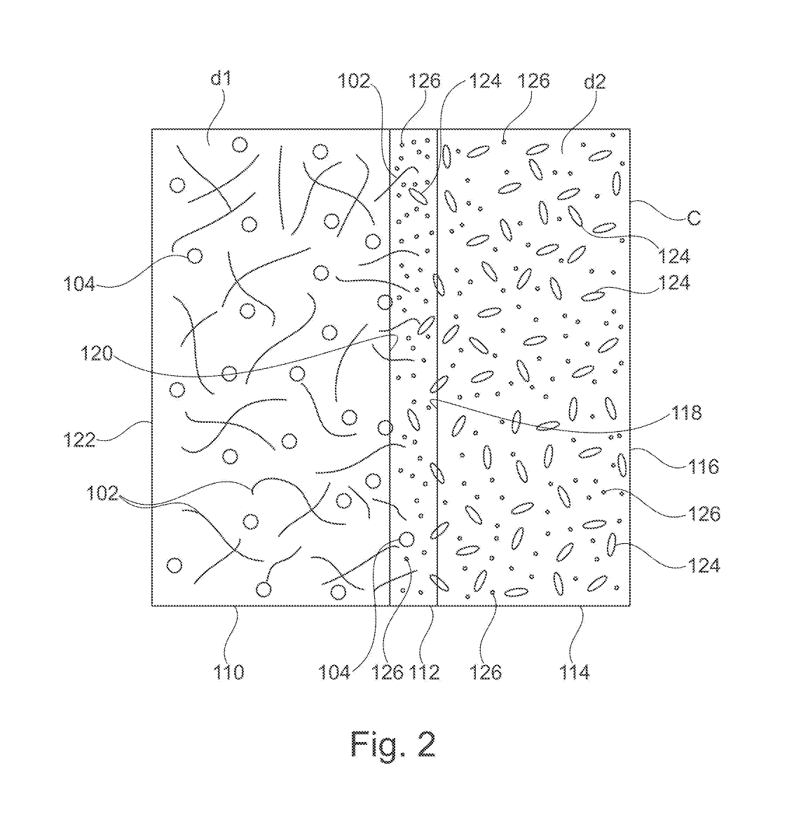

Friction material 100 further includes base layer 110, interfacial layer 112, and surface layer 114 having outer surface 116. Base layer 110 has thickness t1 and surface layer 114 has thickness t2. Thickness t1 is greater than thickness t2. Area C of FIG. 1 is shown in more detail schematically in FIG. 2. FIG. 2 illustrates friction material 100 for a clutch pad comprising base layer 110 having density d1, interfacial layer 112, and surface layer 114 having density d2. Density d1 is less than density d2 thus allowing increased flowabilty of automatic transmission fluid (ATF) throughout friction material base layer once impregnated with binder B (not shown). In other words, surface layer 114 has a higher density than base layer 110. The base material formulation is variable, in other words percentages of fiber and filler components can be optimized for example, but generally a low density base material with at least as much fiber content as filler material content is preferred for good flowability of fluid, such as automatic transmission fluid (ATF) or oil, during use of the friction material.

ATF may also include a friction enhancer as are known in the art for lubrication. In an example aspect, the friction enhancer provides compatibility with the metal clutch, i.e. steel plates, and with the ATF for a clutch or torque converter. Friction enhancers interact with metal surfaces with the polar heads of the friction modifier bonding to the clutch metal surface and repulsive forces from the molecules' tails, for example, aiding in separation of the metal surfaces. Friction enhancers suitable, for example, include those selected from the group: fatty amines, fatty acids, fatty amides, fatty esters, paraffin waxes, oxidized waxes, fatty phosphates, sulfurized fats, long chain alkylamines, long chain alkylphosphites, long chain alkylphosphates, borated long chain polars, or others as known in the art. In an example aspect, the friction enhancer comprises a generally straight oleophilic tail portion including ten to 24 carbons (10-24 C) as well as an active polar head group portion. In another example aspect, the tail portion includes 18 to 24 carbons (18-24 C). The head portions form layers on the friction surfaces by surface absorption. Friction enhancers for ATF must be compatible, meaning do not corrode or cause degradation, with not only the friction material but also the clutch plate, typically made of steel.

Base layer 110 includes a plurality of fibers 102 and filler material 104 as described above. Surface layer 114 includes friction modifier 124 and coupling agent 126. Interfacial layer 112 is exaggerated to show detail. As surface layer 114 is applied or deposited onto base layer 110 by spraying, brush rolling, or other techniques as are known in the art, interfacial layer 112 is formed and includes at least one selected from the group: fibers 102, filler material 104, friction modifier 124, coupling agent 126, or a combination thereof. In an example aspect, friction modifier 124 is selected from the group: Celite®, diatomaceous earth, silicon dioxide, calcium silicate, kaolin, calcined kaolin, activated carbon, or a combination thereof.

The following provides information regarding calcined kaolin clay. As those skilled in the art appreciate, a clay such as kaolin exists naturally in the hydrous form. In the hydrous form, kaolinite minerals form crystal structures that are linked together by hydroxyl containing moieties. Hydrous kaolin may be converted to calcined kaolin containing crystalline mullite and silica, for example, by thermal processes at or above 980° C.

Calcined kaolin clay can be produced from crude kaolin, coarse hydrous kaolin, or fine hydrous kaolin. As those skilled in the art appreciate, kaolin may be mined from various geographic locations including North America, Europe, and Asia. The kaolin may be subjected to preliminary processing and/or beneficiation to facilitate transportation, storage, and handling. For example, crude kaolin can be subjected to one or more of the following operations: crushing, grinding, delamination (wet milling, slurry milling, wet grinding, and the like), filtration, fractionation, pulverization, flotation, selective flocculation, magnetic separation, floc/filtration, bleaching, and the like before or after the heat treatment.

Calcination is effected by heat treating hydrous kaolin at temperatures ranging from about 500° C. to about 1300° C. or higher. In one or more embodiments, the calcined kaolin is thermally prepared at a calcination temperature of at least 1000° C. and at most 1300° C. for a time from about 1 second to about 10 hours, or at least 1050° C. and at most 1250° C. for a time from about 1 minute to about 5 hours, or at least 1100° C. and at most 1200° C. for a time from about 10 minutes to about 4 hours.

In one or more embodiments, the kaolin is heated to a temperature of about 1175 to 1200° C. for a time of about 1 minute to about 2 hours. Calcined, or calcination as used herein, may encompass any degree of calcination, including partial (meta) calcination, full calcination, flash calcination, or combinations thereof.

Calcining or heat treating may be performed in any suitable manner. Heating procedures typically include soak calcining, flash calcining, and/or a combination of flash calcining/soak calcining. In soak calcining, a hydrous kaolin is heat treated at a desired temperature for a period of time (for example, from at least 1 minute to about 5 or more hours), sufficient to dehydroxylate the kaolin and form a major amount of mullite. In addition to mullite formation, in an example embodiment, the calcined kaolin clay includes crystalline polymorphs of silica, amorphous silica, or combinations thereof. In flash calcining, a hydrous kaolin is heated rapidly for a period of at most 10 seconds, typically less than about 1 second. In a flash/soak calcining operation, metakaolin is instantaneously produced during flash calcination and then processed to a finished product requirement using soak calcination. Known devices suitable for carrying out soak calcining include high temperature ovens, and rotary and vertical kilns. Known devices for effecting flash calcining include toroidal fluid flow heating devices.

In a preferred example, friction modifier 124 is Celite®, also referred to interchangeably herein as diatomaceous earth, SiO₂ or silica. In an example aspect, friction modifier 124 can be the same material as filler material 104. In another example aspect, friction modifier 124 is different that filler material 104. In other words, in an example aspect, filler material 104 is a first silica-containing material and friction modifier 124 is a second silica-containing material. In an example aspect, first silica-containing material 104 is selected from the group: diatomaceous earth, silicon dioxide, calcium silicate, or a combination thereof. In an example aspect, second silica-containing material 124 is also selected from the group: diatomaceous earth, silicon dioxide, calcium silicate, calcined kaolin, or a combination thereof. In an example aspect, first and second silica-containing materials 104, 124 are the same or different.

Interfacial layer 112 is also referred to interchangeably herein as interfacial bonding layer or bonding layer. Coupling agent 126 is referred to interchangeably herein as bonding agent, organosilane, or simply as ‘silane’. In an example aspect, coupling agent 126 forms interfacial bonding layer 112 between base layer 110 and surface layer 114 to form composite 150 including base layer 110, interfacial boding layer 112, and surface layer 114. Coupling agent 126, bonding surfaces 118 and 120 to one another, is preferably an organosilane. In an example aspect, the silane is an organosilane having a reactive organic ureido group and a hydrolyzable inorganic triethoxysilyl group. In an example aspect, the phenolic resin forms byproduct water upon curing to react with the hydrolyzable inorganic triethoxysilyl group to form a cross-linked binder. In another example aspect, wherein the coupling agent is an organosilane, the organosilane is 3-ureidopropyl-triethoxysilane, γ-aminopropyltriethoxysilane, or a combination thereof.

In an example aspect, composite 150 is saturated or impregnated with binder B. Binder B is selected from the group: phenolic resin, latex, silane, or a mixture thereof. In an example aspect, binder B is phenolic resin. In an example aspect, friction material composite 150 for a clutch comprises base layer 110, surface layer 114, and interfacial bonding layer 112. Base layer 110 includes plurality of fibers 102 and filler material 104. Surface layer is substantially devoid of fibers and includes friction modifier 124 and coupling agent 126. Interfacial bonding layer 112, disposed between base layer 110 and surface layer 114, includes at least one selected from the group: coupling agent 126, fibers 102, filler material 104, friction modifier 124, or any combination thereof. In an example aspect interfacial bonding layer 112 includes coupling agent 126 and at least partially the plurality of fibers 102, filler material 104, friction modifier 124, or a combination thereof.

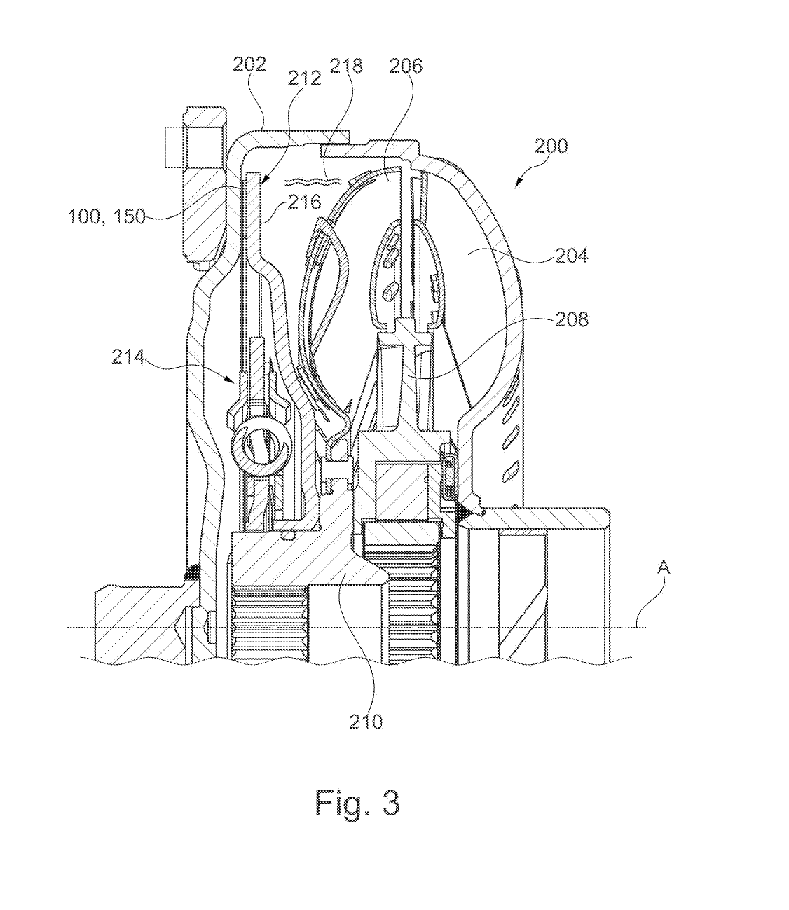

FIG. 3 is a partial cross-sectional view of example torque converter 200 including friction material 100 shown in FIG. 1. In an example aspect, torque converter 200 of FIG. 3 comprises clutch 212 and plate 106 (as shown in FIG. 1).

Friction material 100, 150 is disposed between the clutch and the plate. Torque converter 200 includes cover 202, impeller 204 connected to the cover, turbine 206 in fluid communication with the impeller, stator 208, output hub 210 arranged to non-rotatably connect to an input shaft (not shown) for a transmission, torque converter clutch 212, and vibration damper 214. Clutch 212 includes friction material 100 and piston 216. As is known in the art, piston 216 is displaceable to engage friction material 100 with piston 216 and cover 202 to transmit torque from cover 202 to output hub 210 through friction material 100 and piston 216. Fluid 218 is used to operate clutch 212.

Although a particular example configuration of torque converter 200 is shown in FIG. 3, it should be understood that the use of friction material 100 in a torque converter is not limited to a torque converter as configured in FIG. 3. That is, material 100 is usable in any clutch device, using friction material, for any torque converter configuration known in the art.

A method of making a friction material composite comprises (i) forming a base layer, having oppositely disposed first and second surfaces and a first density, and including a plurality of fibers and a filler material; (ii) mixing a friction modifier and an organosilane coupling agent to form a mixture; (iii) applying the mixture uniformly to the first surface of the base layer to form a friction modifying surface layer, having oppositely disposed third and fourth surfaces and a second density, and an interfacial bonding layer therebetween; and, (iv) saturating the base layer, the interfacial bonding layer, and the friction modifying surface layer with a binder. In an example aspect, the step of applying includes spraying or brush rolling or other techniques as are known in the art. In an example aspect, the step of mixing includes Celite as the friction modifier and 3-ureidopropyl-triethoxysilane or γ-aminopropyltriethoxysilane as the organosilane. In an example aspect, the step of saturating includes a phenolic resin as the binder.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A friction material for a clutch pad comprising:
a base layer including:
a plurality of fibers; and,
a filler material; and,
a surface layer, substantially devoid of fibers, including:
a friction modifier; and,
a coupling agent.

2. The friction material of claim 1, wherein the surface layer has a higher density than the base layer.

3. The friction material of claim 1, wherein coupling agent forms an interfacial bonding layer between the base layer and the surface layer; and, wherein the base layer, interfacial boding layer, and surface layer form a composite.

4. The friction material of claim 3, wherein the composite is saturated with a binder.

5. The friction material of claim 4, wherein the binder is selected from the group: a phenolic resin, a latex, a silane, or a mixture thereof

6. The friction material of claim 5, wherein the binder is phenolic resin.

7. The friction material of claim 1, wherein the plurality of fibers are selected from the group: organic fibers, inorganic fibers, cellulose fibers, cotton fibers, aramid fibers, carbon fibers, or a combination thereof

8. The friction material of claim 1, wherein the filler material is a first silica-containing material.

9. The friction material of claim 8, wherein the first silica-containing material is selected from the group: diatomaceous earth, silicon dioxide, calcium silicate, or a combination thereof.

10. The friction material of claim 1, wherein the friction modifier is activated carbon.

11. The friction material of claim 1, wherein the friction modifier is a second silica-containing material selected from the group: diatomaceous earth, silicon dioxide, calcium silicate, calcined kaolin, or a combination thereof.

12. The friction material of claim 11, wherein the second silica-containing material is Celite®.

13. The friction material of claim 1, wherein the filler material and the friction modifier are the same or different.

14. The friction material of claim 1, wherein the coupling agent is an organosilane.

15. The friction material of claim 14, wherein the organosilane is 3-ureidopropyl-triethoxysilane or γ-aminopropyltriethoxysilane.

16. A friction material composite for a clutch comprising:
a base layer including:
a plurality of fibers; and,
a filler material; and,
a surface layer, substantially devoid of fibers, including:
a friction modifier; and,
a coupling agent; and,
an interfacial bonding layer disposed between the base layer and surface layer and including the coupling agent and at least partially the plurality of fibers, the filler material, and the friction modifier.

17. A torque converter comprising:
a clutch;
a plate;
the friction material of claim 16 disposed between the clutch and the plate.

18. A method of making a friction material composite, the method comprising:
forming a base layer, having oppositely disposed first and second surfaces and a first density, and including a plurality of fibers and a filler material;
mixing a friction modifier and an organosilane coupling agent to form a mixture;
applying the mixture uniformly to the first surface of the base layer to form a friction modifying surface layer, having oppositely disposed third and fourth surfaces and a second density, and an interfacial bonding layer therebetween; and,
saturating the base layer, the interfacial bonding layer, and the friction modifying surface layer with a binder.

19. The method of claim 18, wherein the step of applying includes spraying or brush rolling.

20. The method of claim 18, wherein the step of mixing includes Celite as the friction modifier and 3-ureidopropyl-triethoxysilane or γ-aminopropyltriethoxysilane as the organosilane; and wherein the step of saturating includes a phenolic resin as the binder.
